(19) United States
(12) Patent Application Publication
(10) Pub. No.: US 2021/0310285 A1
(43) Pub. Date: Oct. 7, 2021

(54) WATER-TIGHT SEALING SYSTEM FOR A BATHTUB DOOR

(71) Applicant: Spa World Corporation d/b/a SWCorp, Miami, FL (US)

(72) Inventors: Joseph Schwartz, Hollywood, FL (US); Gunter Felix, Hialeah, FL (US)

(21) Appl. No.: 16/840,711

(22) Filed: Apr. 6, 2020

(51) Int. Cl. E05C 19/16; E06B 7/22

(52) U.S. Cl. CPC E05C 19/16; E06B 7/22; E05C 19/161

(57) ABSTRACT

A water-tight sealing system for a bathtub door may include, but is not limited to, an opening in a side of a bathtub. A door may be coupled to the bathtub and configured to close the bathtub side. Magnetic elements may be positioned on one of a periphery of a door and a periphery of the bathtub side and corresponding metallic elements may be positioned on the other of the periphery of the door and the periphery of the bathtub side. One or more compressible seals may be positioned along the periphery of the door and against the magnetic elements such that the compressible seals are compressed between the magnetic elements and the corresponding metallic elements when the door is closed. Magnetic attraction between the magnetic elements and the corresponding metallic elements may compress the compressible seals to form a water-tight seal between the door and the bathtub.

### TECHNICAL FIELD

The present disclosure generally relates to water-tight sealing systems for a bathtub door and, more particularly, for magnetic water-tight sealing systems.

### BACKGROUND

User-accessibility features such as handles and doors have become increasingly popular for use with bathtubs. For example, walk-in bathtubs may include a door that allows a user to safely enter and exit a bathtub. However, many conventional configurations for bathtub doors require cumbersome latching mechanisms to maintain a seal between a bathtub and the bathtub door. Additionally, many conventional configurations fail to utilize the internal pressure against the sides of the bathtub when liquid is present in the bathtub for securing a bathtub door while retaining the bathtub door in a closed position as a liquid is drained from a bathtub interior.

### SUMMARY

In an embodiment, a water-tight sealing system for a bathtub door may include, but is not limited to, an opening in a side of a bathtub. A door may be coupled to the bathtub and configured to close the opening in the side of the bathtub. One or more magnetic elements may be positioned on at least one of at least a portion of a periphery of a door and at least a portion of a periphery of the opening in the side of the bathtub and one or more metallic elements may be positioned on at least the other of the at least a portion of the periphery of the door and at least a portion of the periphery of the opening in the side of the bathtub. One or more compressible seals may be coupled to and positioned along the periphery of the door and against the one or more magnetic elements such that the one or more compressible seals are configured to be compressed between the one or more magnetic elements and the one or more corresponding metallic elements when the door is closed. Magnetic attraction between the one or more magnetic elements and the one or more corresponding metallic elements may be configured to compress the one or more compressible seals to form a water-tight seal between the door and the side of the bathtub.

One or more of the following features may be included. The one or more magnetic elements may be positioned on at least a portion of a periphery of the door include a plurality of magnetic elements substantially uniformly-spaced around the periphery of the door, thus defining a plurality of substantially uniformly-spaced magnetic elements. The one or more magnetic elements may be positioned on at least a portion of a periphery of the door include a continuous magnetic element extending around the periphery of the door. The one or more magnetic elements may be positioned on at least a portion of a periphery of the door include a first set of magnetic elements positioned along upper edges of the door and a continuous magnetic element positioned around a lower edge of the door. The one or more magnetic elements may be encased within one or more sleeves coupled to the one or more compressible seals. The one or more magnetic elements may be configured to maintain a water-tight seal between the door and the side of the bathtub while the bathtub is at least partially filled with water. One or more protruding portions may extend from at least a portion of the periphery of the opening in the side of the bathtub and one or more channel portions may be positioned within and along at least a portion of the periphery of the door. At least one of the one or more compressible seals may be positioned within at least one of the one or more channel portions of the door such that the at least one compressible seal is configured to be compressed by at least one protruding portion of the one or more protruding portions within the at least one channel portion in response to a magnetic attraction between the one or more magnetic elements and the one or more corresponding metallic elements to form a water-tight seal between the door and the side of the bathtub.

According to another embodiment, a water-tight sealing system for a bathtub door may include an opening in a side of a bathtub. A door may be coupled to the bathtub and configured to close the opening in the side of the bathtub. One or more magnetic elements may be positioned on at least one of at least a portion of a periphery of a door and at least a portion of a periphery of the opening in the side of the bathtub and one or more corresponding magnetically-coupleable elements may be positioned on at least the other of the at least a portion of the periphery of the door and at least a portion of the periphery of the opening in the side of the bathtub. One or more protruding portions may extend from at least a portion of the periphery of the opening in the side of the bathtub and one or more channel portions may extend within and along at least a portion of the periphery of the door. One or more compressible seals may be positioned within the one or more channel portions of the door such that the one or more compressible seals are configured to be compressed by the one or more protruding portions within the one or more channel portions in response to a magnetic attraction between the one or more magnetic elements and the one or more corresponding magnetically-coupleable elements to form a water-tight seal between the door and the side of the bathtub.

One or more of the following features may be included. The one or more corresponding magnetically-coupleable elements may include at least one of: one or more metallic elements, and one or more cooperating magnetic elements. The one or more magnetic elements may be positioned on at least a portion of a periphery of the door include a plurality of magnetic elements substantially uniformly-spaced around the periphery of the door, thus defining a plurality of substantially uniformly-spaced magnetic elements. The one or more magnetic elements may be positioned on at least a portion of a periphery of the door include a continuous magnetic element extending around the periphery of the door. The one or more magnetic elements may be positioned on at least a portion of a periphery of the door include a first set of magnetic elements positioned along upper edges of the door and continuous magnetic element positioned along a lower edge of the door. The one or more magnetic elements may be encased within one or more sleeves coupled to the one or more compressible seals. The one or more protruding portions extending from the at least a portion of the periphery of the opening in the side of the bathtub may include a pair of protruding portions extending from the at least a portion of the periphery of the opening in the side of the bathtub and at least one of the one or more corresponding magnetically-coupleable elements may be positioned between the pair of protruding portions extending from the at least a portion of the periphery of the opening in the side of the bathtub. The one or more channel portions within and along at least a portion of the periphery of the door may include a pair of channel portions within and along at least a portion of the periphery of the door and at least one of the one or more magnetic elements is positioned between the pair of channel portions within and along at least a portion of the periphery of the door.

According to yet another embodiment, a water-tight sealing system for bathtub door may include an opening in a side of a bathtub. A door may be coupled to the bathtub and configured to close the opening in the side of the bathtub. A pair of protruding portions may extend from at least a portion of the periphery of the opening in the side of the bathtub and a pair of channel portions may extend within and along at least a portion of the periphery of the door. One or more magnetic elements may be positioned on at least a portion of a periphery of the door and at least one magnetic element may be positioned between the pair of protruding portions extending from the at least a portion of the periphery of the opening in the side of the bathtub. One or more corresponding metallic elements may be positioned on at least a portion of a periphery of the opening in the side of the bathtub and at least one corresponding metallic element is positioned between the pair of channel portions within and along at least a portion of the periphery of the door. A compressible seal may be positioned within each channel portion of the pair of channel portions of the door such that each compressible seal may be configured to be compressed by the pair of protruding portions within the pair of channel portions in response to a magnetic attraction between the one or more magnetic elements and the one or more corresponding metallic elements to form a water-tight seal between the door and the side of the bathtub.

One or more of the following features may be included. The one or more magnetic elements positioned on at least a portion of a periphery of the door may include a plurality of magnetic elements substantially uniformly-spaced around the periphery of the door, thus defining a plurality of substantially uniformly-spaced magnetic elements. The one or more magnetic elements positioned on at least a portion of a periphery of the door may include a continuous magnetic element extending around the periphery of the door. The one or more magnetic elements positioned on at least a portion of a periphery of the door may include a first set of magnetic elements positioned along upper edges of the door and continuous magnetic element positioned along a lower edge of the door. The one or more magnetic elements may be encased within one or more sleeves coupled to the one or more compressible seals. The one or more magnetic elements may be configured to maintain a water-tight seal between the door and the side of the bathtub while the bathtub is at least partially filled with water.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a top view of a bathtub including a water-tight sealing system, according to an example embodiment;

FIGS. 2 and 3 are side views of bathtubs, according to various example embodiments;

FIGS. 4-5 are diagrammatic views of a water-tight sealing system, according to various example embodiments;

FIGS. 6-10 are side views of water-tight sealing systems with various magnetic element arrangements, according to various example embodiments;

FIGS. 11A-11B are diagrammatic views of magnetic elements encased in various sleeves coupled to compressible sleeves, according to various example embodiments; and

FIG. 12 is a diagrammatic view of a water-tight sealing system, according to an example embodiment.

Like reference symbols in the various drawings indicate like elements.

### DETAILED DESCRIPTION OF EXAMPLE EMBODIMENTS

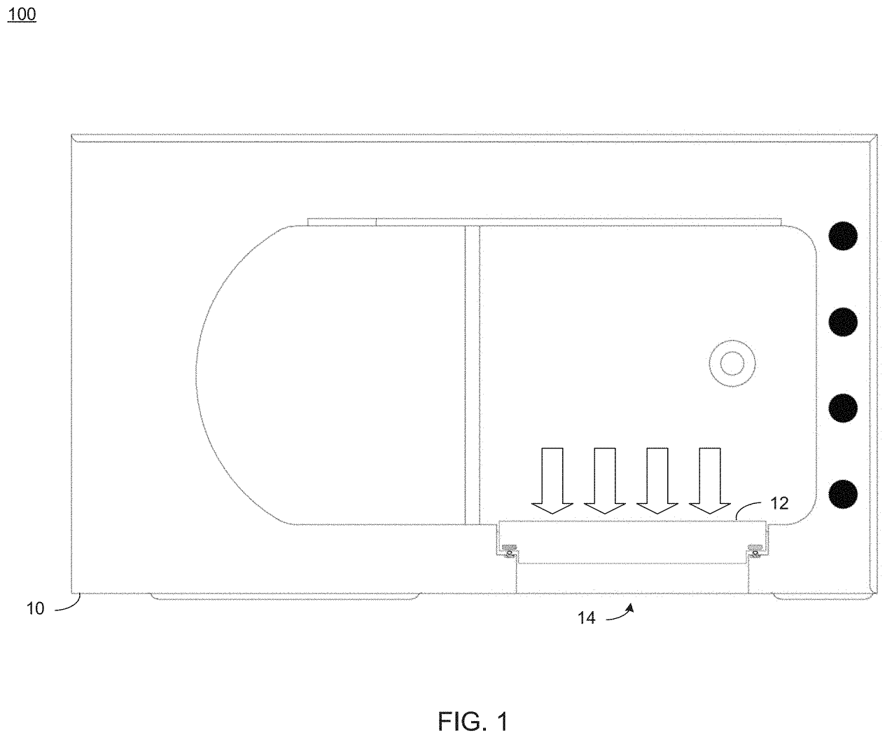

In general, consistent with the present disclosure, a water-tight sealing system for a bathtub door is provided. For example, and referring generally to FIGS. 1 through 12, in some embodiments, a bathtub may configured with a door and a water-tight sealing system to prevent a liquid (e.g., water) from leaking out of the bathtub. As will be discussed in greater detail below, embodiments of the present disclosure may retain a bathtub door in a closed position (e.g., a water-tight seal formed between the bathtub door and an opening/doorway of the bathtub) when the bathtub is at least partially filled with liquid, such as water. Specifically, the water-tight sealing system may include magnetic elements and corresponding magnetically-coupleable elements positioned on the bathtub door and the opening in the side of the bathtub that are configured to retain the bathtub door in a closed position with sufficient force to prevent accidental or unintentional opening of the bathtub door until enough water is added to the bathtub to provide pressure against the bathtub door (e.g., wherein the pressure of the water against the bathtub door may aid in closing and/or sealing the door in the closed position). In this manner, the use of complicated locking or sliding mechanisms to latch the bathtub door may be avoided. Additionally and in some embodiments, the incorporation of magnetic elements and corresponding metallic elements may allow the surfaces of the bathtub door and the sides of the bathtub to be unencumbered by external latching mechanisms. Instead and as will discussed in greater detail below, the integrated positioning of magnetic elements and corresponding metallic elements may provide minimal user interaction to open and close the bathtub door while providing sufficient force to retain the bathtub in a closed position until enough water is added to press against the bathtub door.

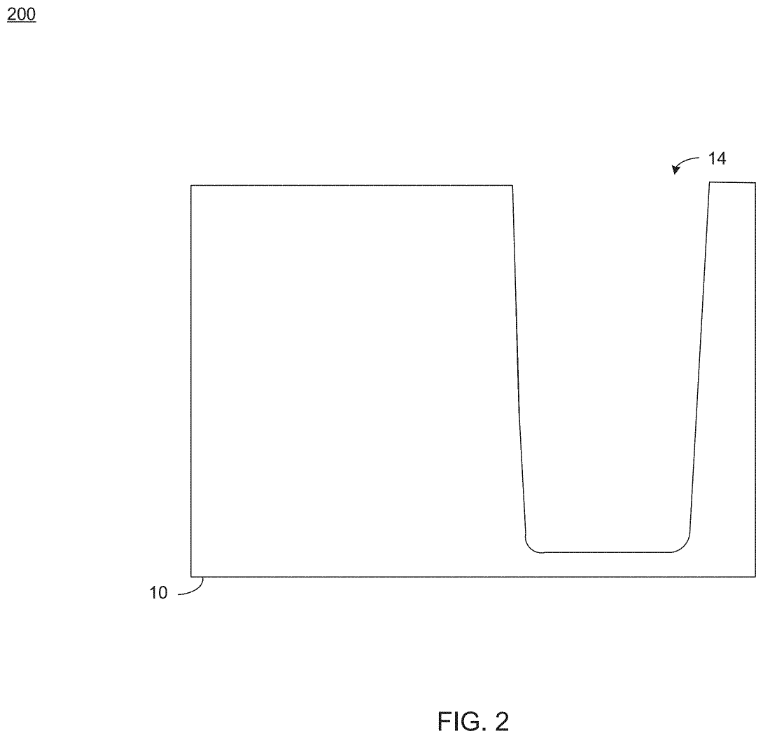

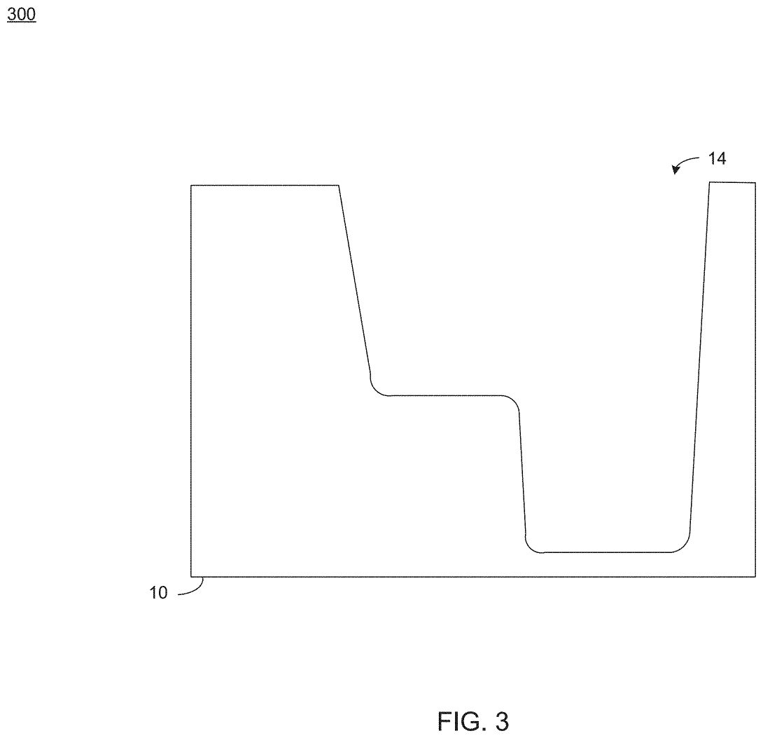

Referring to FIGS. 1-3 and in some implementations, a bathtub (e.g., bathtub 10) may be any volume or tank configured to hold liquid. As is known in the art, a bathtub may be made from any combination of plastics, fiberglass, stones, metals, etc. While the term “bathtub” may be used throughout the present disclosure, it will be appreciated that the water-tight sealing system of the present disclosure may be applied to any volume or tank. In some implementations, a bathtub may include an opening configured to receive a door (e.g., bathtub door 12). For example, a bathtub (e.g., bathtub 10) may include an opening in or on the side (e.g., bathtub side opening 14) that is configured to receive a door (e.g., bathtub door 12). As shown in the examples of FIGS. 2-3, it will be appreciated that there may be various configurations of bathtub side opening 14. For example, the bathtub side opening in FIG. 2 may accommodate a door accessible from one end of the bathtub while the bathtub side opening in FIG. 3 may accommodate a door accessible from either end of the bathtub. In the example of FIG. 3, a user may access both an integrated seating portion of bathtub 10 or the drain end of bathtub 10. While two configurations of bathtub side openings have been shown and described, it will be appreciated that bathtub side opening 14 may be configured in any arrangement.

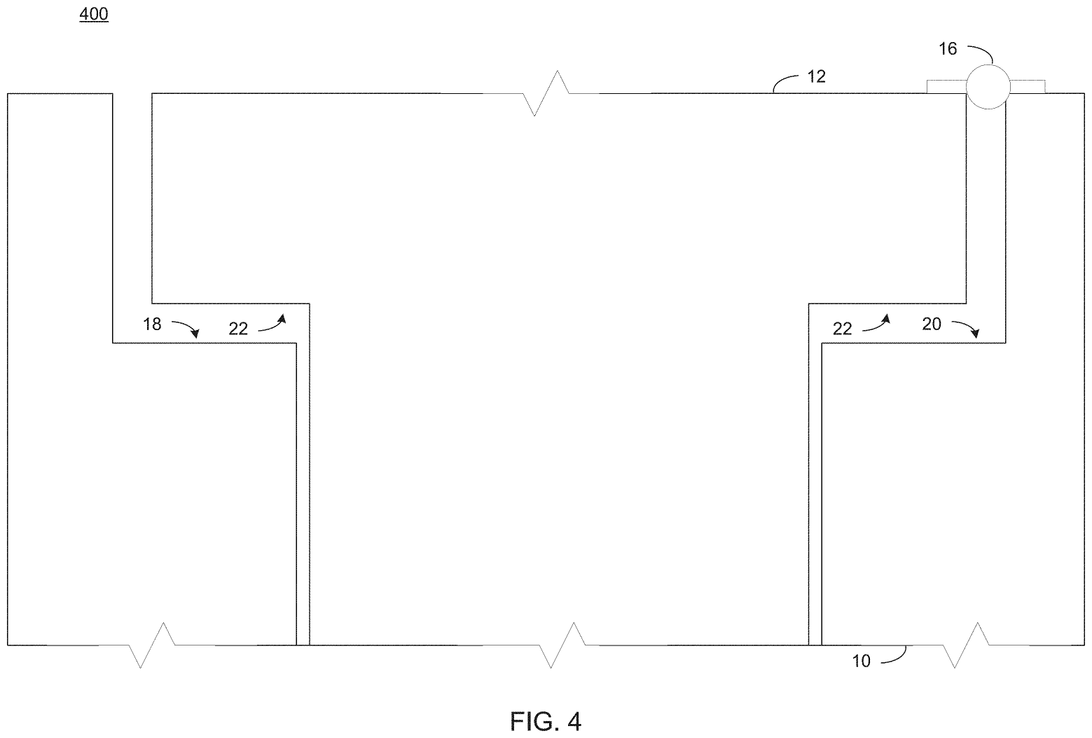

Referring again to the example of FIG. 1 and in some embodiments, a water-tight sealing system (e.g., water-tight sealing system 100) may include a bathtub side opening (e.g., bathtub side opening 14) and a door (e.g., bathtub door 12) coupled to the bathtub and configured to close the opening in the side of the bathtub. As noted above, while bathtub door 12 is described as a door of a bathtub, it will be appreciated that the water-tight sealing system of the present disclosure may be utilized in any tank or volume with an openable portion that is configured to be closed and sealed with a door portion. Accordingly, bathtub door 12 of water-tight sealing system 100 may be any door coupled to any tank or volume. In some embodiments, bathtub door 12 may be coupled to bathtub 10 via one or more hinges and/or other fasteners that are configured to allow bathtub 12 to move between an open position and a closed position. For example and referring also to FIG. 4, bathtub door 12 may be configured to be coupled to bathtub 10 via one or more hinges (e.g., hinge 16) such that bathtub door 12 is capable of opening and closing by rotating about hinge 16. In the example of FIG. 4, bathtub door 12 may be configured to open by rotating about hinge 16 toward one of the ends of bathtub 10.

In some embodiments, hinge 16 may include a biasing element configured to bias bathtub door 12 into a closed position. For example, hinge 16 may include a spring configured to bias bathtub door 12 in a closed position (e.g., a spring-loaded hinge). In this manner, bathtub door 12 may be biased in a closed position to form a watertight seal between bathtub door 12 and bathtub 10. In some embodiments, force may be applied (e.g., by a person) to overcome the biasing force of the spring of hinge 16 in order to open bathtub door 12. It will be appreciated that while a spring has been described as a biasing element, that any biasing element may be used within the scope of the present disclosure. While an example of a hinge has been provided to couple bathtub door 12 to bathtub 10, it will be appreciated that various coupling mechanisms may be used within the scope of the present disclosure to couple bathtub door 12 to the side of bathtub 10.

In some embodiments, bathtub door 12 may be configured to open and close by rotating about hinges (not shown) in other configurations. For example and in some embodiments, bathtub door 12 may be coupled to bathtub 10 via one or more hinges positioned along a bottom of bathtub side opening 14. In this manner, bathtub door 12 may be configured to open by rotating about one or more hinges down into the bathtub. Accordingly, it will be appreciated that bathtub door 12 may be configured to move between an open position (e.g., a position where a user may be able to access the interior of bathtub 10) and a closed position (e.g., a position where the bathtub interior is sealed or closed from outside access).

Referring again to the example of FIG. 4 and in some implementations, bathtub door 12 may be shaped to fit at least partially within bathtub side opening 14. For example and in some embodiments, opposing sides of bathtub side opening 14 may include one or more recesses (e.g., recesses 18, 20) configured to receive a rim (e.g., rim 22) of bathtub door 12. In some embodiments, an interior surface of rim 22 may be configured to mate with recesses 18, 20 of bathtub side opening 14. In some embodiments, rim 22 may extend around a portion of the periphery of bathtub door 12 and/or around the entire periphery of bathtub door 12. In this manner, bathtub door 12 may be configured to be closed against recesses 18, 20 defined within bathtub side opening 14. As will be discussed in greater detail below, the mating of rim 22 of bathtub door 12 and recesses 18, 20 of bathtub door opening 14 may define, at least in part, a water-tight seal of water-tight sealing system 100.

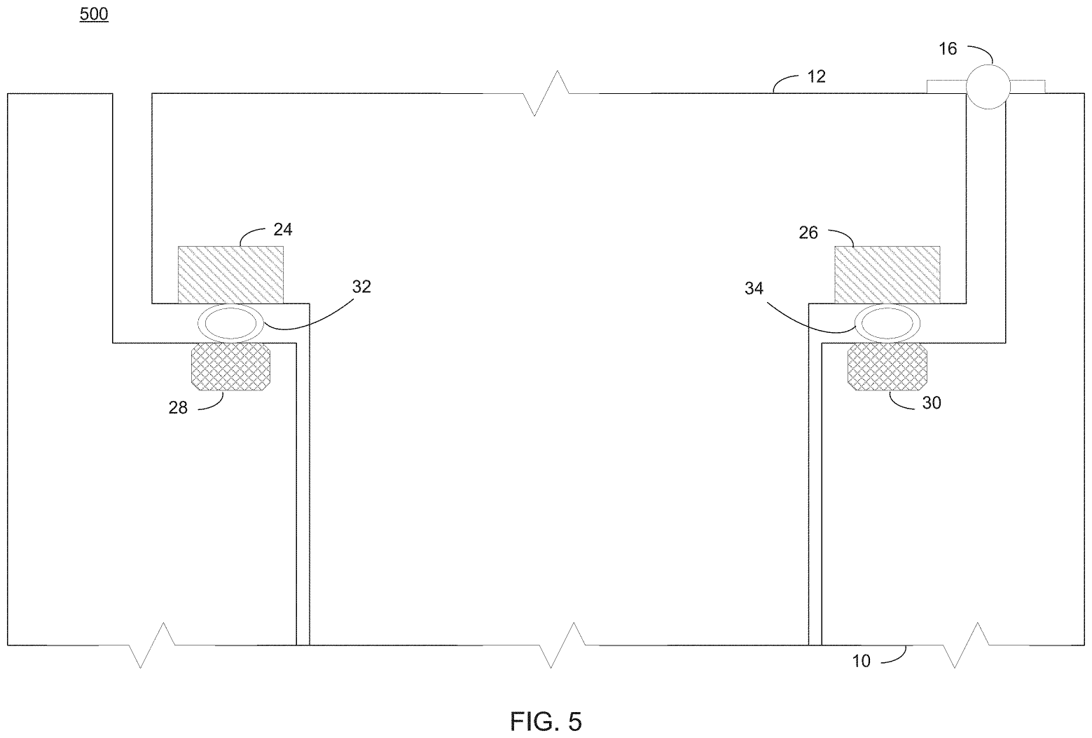

Referring also to the example of FIG. 5 and in some embodiments, water-tight sealing system 100 may include one or more magnetic elements positioned on at least a portion of a periphery of the door. In some embodiments, a magnetic element (e.g., magnetic elements 24, 26) may generally include a material that exhibits properties of magnetism, such as attracting other objects or aligning itself in an external magnetic field. As shown in the example of FIG. 5 and in some embodiments, magnetic elements 24, 26 may be positioned on at least a portion of the periphery of bathtub door 12. For example, magnetic elements 24, 26 may be positioned along at least a portion of rim 22 of bathtub door 12. As will be discussed in greater detail below, the one or more magnetic elements (e.g., magnetic elements 24, 26) may be positioned in various arrangements on the periphery of the bathtub door (e.g., bathtub door 12).

Referring again to the example of FIG. 5 and in some embodiments, water-tight sealing system 100 may include one or more corresponding magnetically-coupleable elements positioned on at least a portion of a periphery of the opening in the side of the bathtub. The one or more corresponding magnetically-coupleable elements may include at least one of one or more metallic elements, and one or more cooperating magnetic elements. A metallic element (e.g., metallic elements 28, 30) may generally include a ferromagnetic metal. As is known in the art, a ferromagnetic material is a material that has a high susceptibility to magnetization, the strength of which depends on that of the applied magnetic field, and which may persist after removal of the applied field. A cooperating magnetic element may generally include a magnetic element positioned or oriented such that the magnetic attraction between a magnetic element and a cooperating magnetic element facilitates magnetic coupling. For example, suppose magnetic element 24 is oriented such that the “north” orientation of the magnetic element is oriented toward recess 18 of bathtub side opening 14 and that the cooperating magnetic element 28 is oriented such that the “south” orientation of the cooperating magnetic element is oriented toward rim 22 of bathtub door 12. In this example, the magnetic attraction between the “north” pole of magnetic element 24 and the “south” pole of cooperating magnetic element 28 may generate a magnetic attraction between magnetic element 24 and cooperating magnetic element 28. While several examples below may reference one or metallic elements, it will be appreciated that any reference to metallic elements equally applies to cooperating magnetic elements.

As shown in the example of FIG. 5 and in some embodiments, metallic elements 28, 30 may be positioned on at least a portion of the periphery of bathtub side opening 14. For example, metallic elements 28, 30 may be positioned along at least a portion of recesses 18, 20 of bathtub side opening 14. As will be discussed in greater detail below, the one or more metallic elements (e.g., metallic elements 28, 30) may be positioned in various arrangements on the periphery of the bathtub side opening (e.g., bathtub side opening 14). In some embodiments, the one or more metallic elements (e.g., metallic elements 28, 30) may be positioned on at least a portion of the periphery of the opening in the side of the bathtub (e.g., bathtub side opening 14) such that one or more metallic elements (e.g., metallic elements 28, 30) correspond in position to the one or more magnetic elements (e.g., magnetic elements 24, 26), thus defining one or more corresponding metallic elements.

Referring again to the example of FIG. 5 and in some embodiments, magnetic element 24 may be positioned on rim 22 of bathtub door 12 and magnetic element 26 may be positioned on the opposite side of bathtub door 12 on rim 12 of bathtub door 12. In this example, corresponding metallic element 28 may be positioned on or within recess 18 of bathtub side opening 14 across a gap from magnetic element 24 formed between bathtub side opening 14 and bathtub door 12 when bathtub door 12 is moved into a closed position (e.g., via hinge 16) and corresponding metallic element 30 may be positioned on or within recess 20 on the opposite side of bathtub side opening 14 across a gap from magnetic element 26 formed between bathtub side opening 14 and bathtub door 12 when bathtub door 12 is moved into a closed position. While an example has been described including two magnetic elements and two corresponding metallic elements, it will be appreciated that any number of magnetic elements and/or metallic elements may be used within the scope of the present disclosure. It will also be appreciated that one or more magnetic elements may be positioned on at least a portion of a periphery of the opening in the side of the bathtub and one or more metallic elements may be positioned on at least a portion of a periphery of a bathtub door. Additionally, it will be appreciated that any combination of magnetic and metallic portions may be positioned on at least a portion of a periphery of each of the bathtub door and opening in the side of the bathtub. In this manner, the one or more magnetic elements may be positioned on at least one of at least a portion of a periphery of a door and at least a portion of a periphery of the opening in the side of the bathtub and the one or more metallic elements may be positioned at least the other of the at least a portion of the periphery of the door and at least a portion of the periphery of the opening in the side of the bathtub.

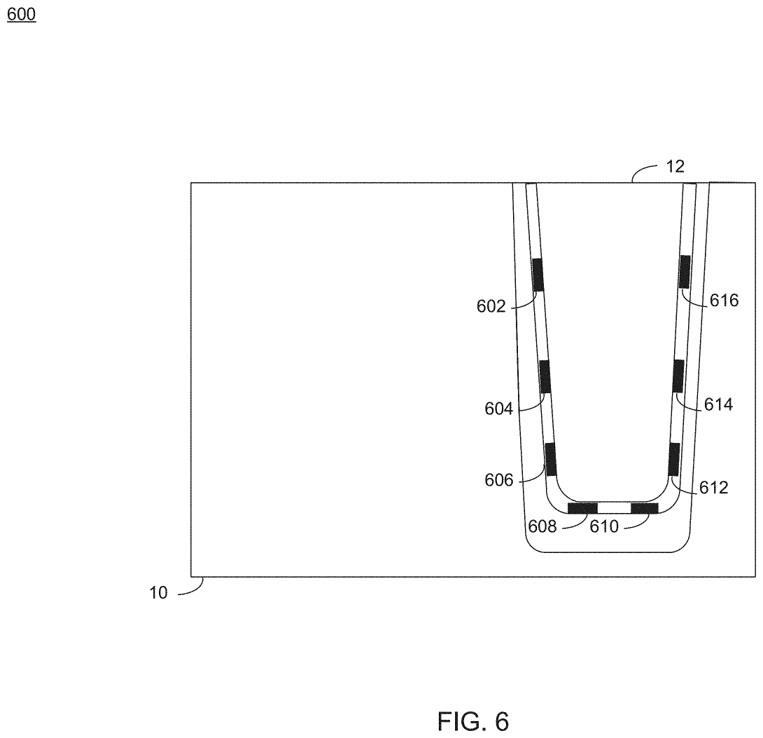

In some embodiments, the one or more magnetic elements (e.g., magnetic elements 24, 26) and the one or more corresponding metallic elements (e.g., metallic elements 28, 30) may be arranged in various configurations on at least a portion of a periphery of each of the bathtub door and opening in the side of the bathtub. Referring also to the example of FIG. 6 and in some embodiments, the one or more magnetic elements positioned on at least a portion of a periphery of the door may include a plurality of magnetic elements (e.g., magnetic elements 602, 604, 606, 608, 610, 612, 614 616) substantially uniformly-spaced around the periphery of the door, thus defining a plurality of substantially uniformly-spaced magnetic elements. Substantially uniformly-spaced may generally indicate that the plurality of magnetic elements are spaced within a threshold distance (e.g., 10%) of uniformly-spaced. In some embodiments, the plurality of substantially uniformly-spaced magnetic elements may be substantially equal in size and/or magnetic flux density. In this manner, substantially equal amounts of force may be applied between the substantially uniformly-spaced magnetic elements. However, it will be appreciated that any sized magnetic elements with varying magnetic flux densities may be used within the scope of the present disclosure.

In some embodiments, the one or more corresponding metallic elements positioned on at least a portion of a periphery of the opening in the side of the bathtub may include a plurality of corresponding metallic elements substantially uniformly-spaced around the periphery of the door in positions corresponding to the plurality of substantially uniformly-spaced magnetic elements, thus defining a plurality of substantially uniformly-spaced corresponding metallic elements. As described above relative to the substantially uniformly-spaced magnetic elements, a plurality of substantially uniformly-spaced corresponding metallic portions may be spaced within a threshold distance (e.g., 10%) of uniformly-spaced.

In some embodiments, the one or more corresponding metallic portions may include a single, continuous metallic element positioned around at least a portion of the periphery of the opening of the side of the tub. In this manner, various arrangements and numbers of magnetic elements may be positioned on at least a portion of the periphery of the bathtub door without requiring mirrored corresponding metallic portions on at least a portion of the periphery of the opening of the side of the bathtub. However, it will be appreciated that any number or spacing of corresponding metallic portions may be positioned on at least a portion of the periphery of the opening of the side of the tub while a plurality of substantially uniformly-spaced magnetic elements (e.g., magnetic elements 602, 604, 606, 608, 610, 612, 614 616) may be positioned around at least a portion of the bathtub door (e.g., bathtub door 12).

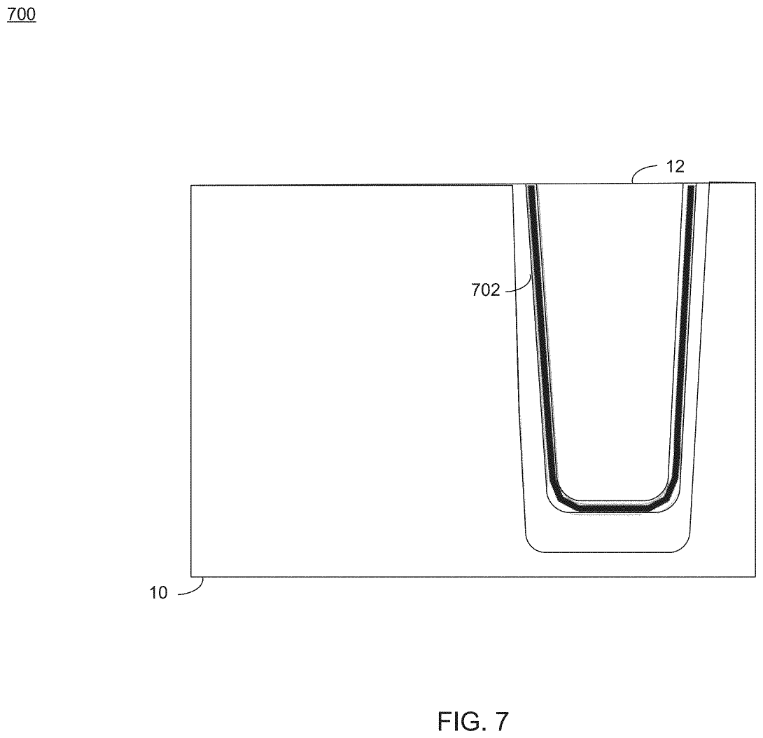

Referring also to the example of FIG. 7 and in some embodiments, the one or more magnetic elements positioned on at least a portion of a periphery of the door may include a single, continuous magnetic element (e.g., magnetic element 702) extending around the periphery of the door. In this manner, an equally distributed amount force may be applied along the periphery of the bathtub door resulting from the magnetic attraction between the single, continuous magnetic element (e.g., magnetic element 702) extending around the periphery of the bathtub door. As will be discussed in greater detail below and in some embodiments, an equal magnetic attraction along the periphery of bathtub door may result in an equally strong water-tight sealing between the bathtub door and the opening in the side of the bathtub.

As discussed above and in some embodiments, the one or more corresponding metallic elements positioned on at least a portion of a periphery of the opening in the side of the bathtub may include a corresponding single, continuous metallic element extending around the periphery of the door corresponding to the single, continuous magnetic element (e.g., magnetic element 702). However, it will also be appreciated that the one or more corresponding metallic elements may include a plurality of metallic elements positioned in various configurations along at least a portion of the periphery of the opening of the side of the bathtub corresponding to the single, continuous magnetic element (e.g., magnetic element 702).

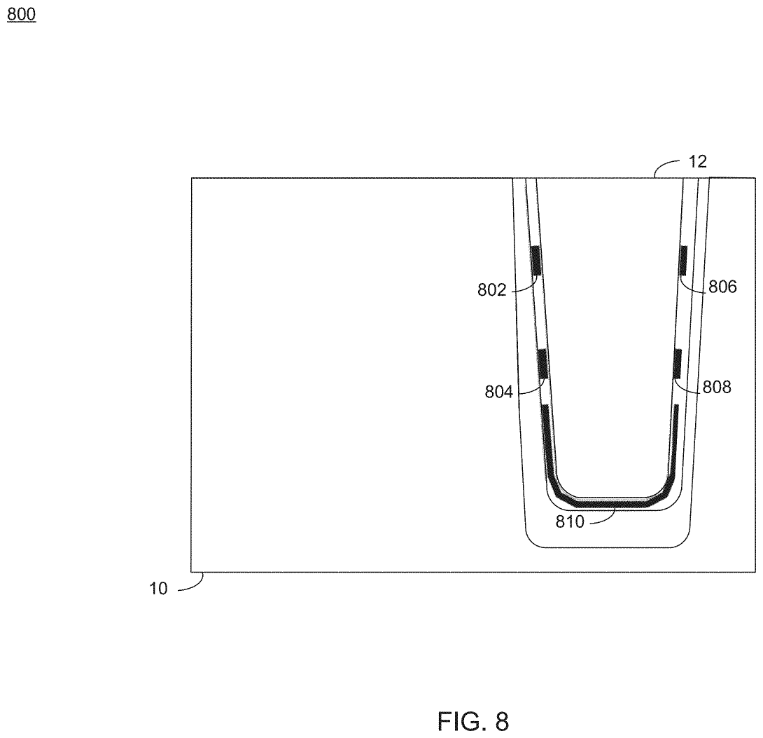

Referring also to the example of FIG. 8 and in some embodiments, the one or more magnetic elements positioned on at least a portion of a periphery of the door may include a first set of magnetic elements positioned along upper edges of the door and a continuous magnetic element positioned along a lower edge of the door. For example, a first set of magnetic elements (e.g., magnetic elements 802, 804, 806, 808) may be positioned along the upper edges of the bathtub door (e.g., bathtub door 12) and a continuous magnetic element (e.g., magnetic element 810) may be positioned along a lower edge of the bathtub door (e.g., bathtub door 12) where upper and lower may be relative to the top and bottom of bathtub door 12. In this manner, the magnetic attraction (e.g., magnetic flux density) between the lower portion of the bathtub door and the lower portion of the opening of the side of the bathtub may be greater than the magnetic attraction (e.g., magnetic flux density) between the upper portion of the bathtub door and the upper portion of the opening of the side of the bathtub based on the magnetic flux density of the continuous magnetic element (e.g., magnetic element 810) positioned along a lower edge of the door being greater than the magnetic flux density of the first set of magnetic elements (e.g., magnetic elements 802, 804, 806, 808) positioned along the upper edges of the bathtub door. As will be discussed in greater detail below and in some embodiments, greater magnetic attraction may result in a stronger water-tight sealing between the bathtub door and the opening in the side of the bathtub.

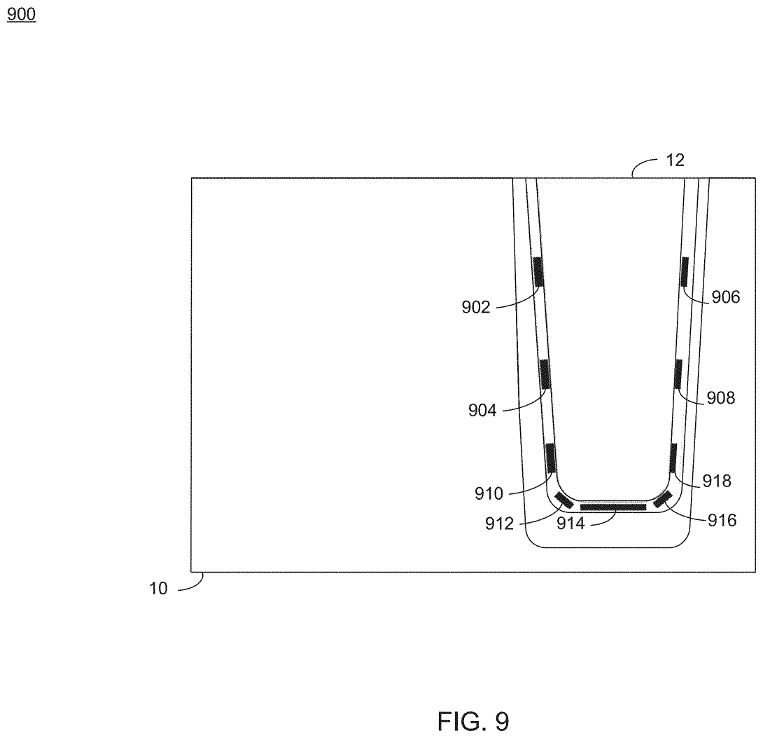

Referring also to the example of FIG. 9 and in some embodiments, a first set of magnetic elements (e.g., magnetic elements 902, 904, 906, 908) may be positioned along the upper edges of the bathtub door (e.g., bathtub door 12) and a second set of magnetic elements (e.g., magnetic elements 910, 912, 914, 916, 918) may be positioned along a lower edge of the bathtub door (e.g., bathtub door 12) where upper and lower may be relative to the top and bottom of bathtub door 12. As shown in this example, the second set of magnetic elements (e.g., magnetic elements 910, 912, 914, 916, 918) may include more magnetic elements and/or magnetic elements with greater magnetic flux density than the first set of magnetic elements (e.g., magnetic elements 902, 904, 906, 908). In this manner, the magnetic attraction (e.g., magnetic flux density) between the lower portion of the bathtub door and the lower portion of the opening of the side of the bathtub may be greater than the magnetic attraction (e.g., magnetic flux density) between the lower portion of the bathtub door and the lower portion of the opening of the side of the bathtub based on the second set of magnetic elements positioned along a lower edge of the door having a greater magnetic flux density than the first set of magnetic elements positioned along the upper edges of the bathtub door.

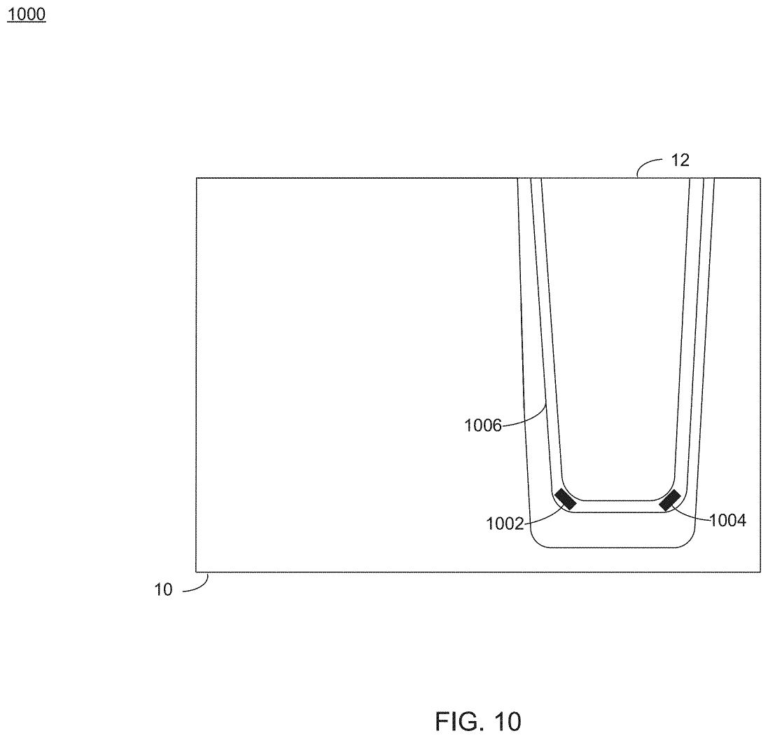

Referring also to the example of FIG. 10 and in some embodiments, magnetic elements may be positioned on bottom corner portions of the bathtub door. For example, magnetic elements 1002, 1004 may be positioned along the bottom corners of bathtub door 12. As will be discussed in greater detail below and in some embodiments, magnetic elements 1002, 1004 may be positioned relative to a compressible seal (e.g., compressible seal 1006) such that compressible seal 1006 is configured to be compressed between magnetic elements 1002, 1004 and the one or more corresponding metallic elements when the bathtub door 12 is closed (e.g., moved into a closed position).

Referring again to the example of FIG. 5 and in some embodiments, water-tight sealing system 100 may include one or more compressible seals coupled to and positioned along the periphery of the door and against the one or more magnetic elements such that the one or more compressible seals are configured to be compressed between the one or more magnetic elements and the one or more corresponding metallic elements when the door is closed. In some embodiments, a compressible seal may generally include any device or material configured to be compressed to close or removably block a gap between adjacent structures. For example, a compressible seal may be formed from an elastomeric material configured to retain an initial shape or structure after being compressed. However, it will be appreciated that a compressible seal may be formed from various materials known to those of ordinary skill in the art. As shown in the example of FIG. 5, one or more compressible seals (e.g., compressible seals 32, 34) may be coupled to and positioned along the periphery of the bathtub door (e.g., bathtub door 12) and against the one or more magnetic elements (e.g., magnetic elements 24, 26) such that the one or more compressible seals (e.g., compressible seals 32, 34) are configured to be compressed between the one or more magnetic elements (e.g., magnetic elements 24, 26) and the one or more corresponding metallic elements (e.g., metallic elements 28, 30) when the bathtub door (e.g., bathtub door 12) is closed (e.g., moved into a closed position).

In some embodiments, when a bathtub door (e.g., bathtub door 12) is moved into a closed position, the one or more compressible seals (e.g., compressible seals 32, 34) coupled to and positioned against the one or more magnetic elements (e.g., magnetic elements 24, 26) positioned on at least a portion of the periphery of the rim (e.g., rim 22) of the bathtub door (e.g., bathtub door 12) may be brought into contact with the recesses (e.g., recesses 18, 20) formed in the opening in the side of the bathtub (e.g., bathtub side opening 14). In some embodiments, the positioning of the bathtub door (e.g., bathtub door 12) into a closed position may bring the one or more magnetic elements (e.g., magnetic elements 24, 26) into proximity with the one or more metallic elements (e.g., magnetic elements 24, 26) such that the magnetic attraction between the one or more magnetic elements (e.g., magnetic elements 24, 26) and the one or more metallic elements (e.g., metallic elements 28, 30) may cause the one or more compressible seals (e.g., compressible seals 32, 34) are configured to be compressed between the one or more magnetic elements (e.g., magnetic elements 24, 26) and the one or more corresponding metallic elements (e.g., metallic elements 28, 30). In this manner, magnetic attraction between the one or more magnetic elements (e.g., magnetic elements 24, 26) and the one or more corresponding metallic elements (e.g., metallic elements 28, 30) may be configured to compress the one or more compressible seals (e.g., compressible seals 32, 34) to form a water-tight seal between the door (e.g., bathtub door 12) and the side of the bathtub (e.g., bathtub side opening 14).

As discussed above and in some embodiments, the strength of the water-tight seal between the bathtub door and the bathtub may be based upon, at least in part, the magnetic attraction between the one or more magnetic elements and the one or more corresponding metallic elements of the water-tight sealing system. For example and in some embodiments, water-tight sealing system 100 may include one or more magnetic elements (e.g., magnetic elements 24, 26) and one or more corresponding metallic elements (e.g., metallic elements 28, 30) configured to maintain a water-tight seal between the bathtub door (e.g., bathtub door 12) and the side of the bathtub (e.g., bathtub side opening 14) while liquid is added to and/or drained from the bathtub by compressing one or more compressible seals (e.g., compressible seals 32, 34) are configured to be compressed between the one or more magnetic elements (e.g., magnetic elements 24, 26) and the one or more corresponding metallic elements (e.g., metallic elements 28, 30) via the magnetic attraction between the one or more magnetic elements (e.g., magnetic elements 24, 26) and the one or more corresponding metallic elements (e.g., metallic elements 28, 30). As discussed above, water-tight sealing system may be configured to provide a stronger water-tight seal at a lower portion of the bathtub door and the side of the bathtub than at a higher portion of the bathtub door and the side of the bathtub based on the pressure applied by liquid added to the bathtub.

Referring again to the example of FIG. 1 and in some embodiments, as a liquid (e.g., water) is added to the interior of bathtub 10, pressure may increase against the sides of the interior of bathtub 10. For example, as the liquid fills the interior of bathtub 10, the liquid may apply pressure against bathtub door 12 (e.g., represented by arrows pointing at bathtub door 12). Accordingly, the increase in pressure may cause the strength of a water-tight seal formed between bathtub door 12 and the side of the bathtub to increase. Conversely, as the liquid is drained or otherwise removed from the interior of bathtub 10, the pressure against the sides of the interior of bathtub 10 and bathtub door 12 may decrease. Accordingly and in conventional configurations, the water-tight seal between bathtub door 12 and the side of the bathtub may open or loosen, potentially causing liquid to leak from the interior of bathtub 10 to the exterior. Instead of utilizing latching mechanisms, water-tight sealing system 100 may utilize magnetic attraction between one or more magnetic elements positioned on at least a portion of a periphery of the bathtub door and one or more metallic elements positioned on at least a portion of a periphery of the opening in the side of bathtub to form and maintain a water-tight seal between the bathtub door and the side of the bathtub.

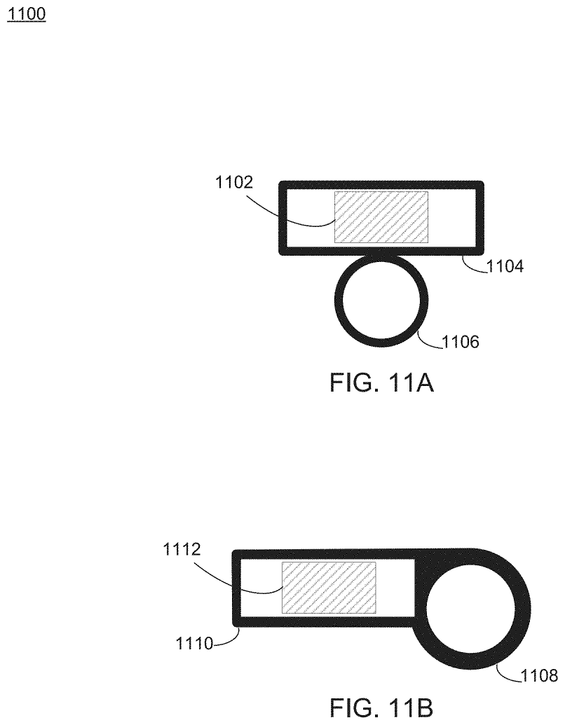

Referring also to the example of FIGS. 11A and 11B and in some embodiments, water-tight sealing system 100 may include one or more magnetic elements encased within a sleeve coupled to the one or more compressible seals. A sleeve may generally include hollowed structure. In some embodiments, a sleeve may be formed from an elastomeric material, plastic, metal, etc. It will be appreciated that a sleeve may be formed of any material within the scope of the present disclosure. As shown in the example of FIG. 11A and in some embodiments, a magnetic element (e.g., magnetic element 1102) may be encased within a sleeve (e.g., sleeve 1104) coupled to a compressible seal (e.g., compressible seal 1106). In this example, compressible seal 1106 may be coupled at the center of sleeve 1104. However and as will be discussed in greater detail below, it will be appreciated that any number of compressible seals may be coupled to any number of sleeves in various configurations and at various locations on the sleeves. In some embodiments, sleeve 1104 may be secured (e.g., via adhesive, fasteners, combinations thereof, etc.) to at least a portion of the periphery of bathtub door 12. In some embodiments, the sleeve may be coupled to one or more compressible seals such that magnetic attraction between the one or more magnetic elements (e.g., magnetic element 1102) and one or more corresponding metallic elements is configured to compress the one or more compressible seals between the sleeve and the opening in the side of the bathtub (e.g., recesses 18, 20 of bathtub side opening 14). In this manner and as shown in FIG. 5, water-tight sealing system 100 may form a water-tight seal between bathtub door 12 and the side of bathtub 10 in the gap defined between magnetic elements 24, 26 and corresponding metallic elements 28, 30.

Referring also to the example of FIG. 11B and in some embodiments, one or more compressible seals may be coupled to a distal end one or more sleeves encasing one or more magnetic elements. For example, compressible seal 1008 may be coupled to a distal end of sleeve 1110. In this manner, magnetic attraction between the one or more magnetic elements (e.g., magnetic element 1112) and one or more corresponding metallic elements may be configured to compress the one or more compressible seals (e.g., compressible seal 1108) between the bathtub door (e.g., bathtub door 12) and the opening in the side of the bathtub (e.g., bathtub side opening 14). In this manner, water-tight sealing system 100 may form a water-tight seal between bathtub door 12 and the side of bathtub 10 on a distal end of sleeve 1110.

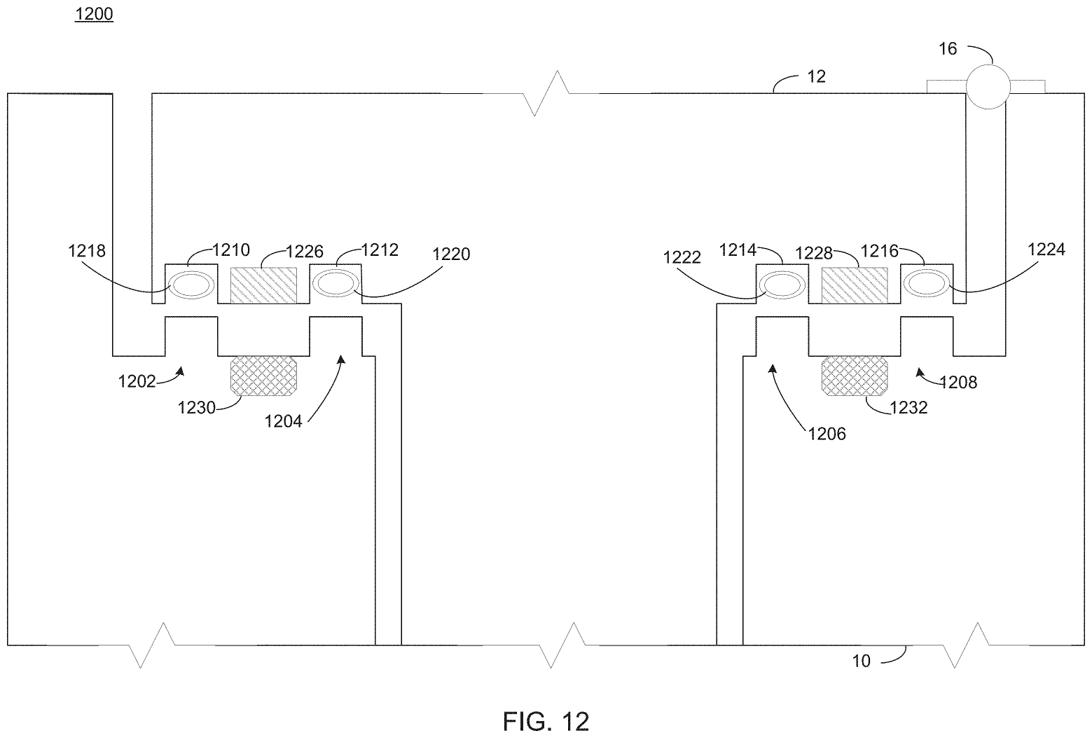

Referring also to the example of FIG. 12 and in some embodiments, water-tight sealing system 100 may include one or more protruding portions extending from at least a portion of the periphery of the opening in the side of the bathtub and one or more channel portions within and along at least a portion of the periphery of the door. As shown in the example of FIGS. 5 and 12, one or more protruding portions (e.g., protruding portions 1202, 1204, 1206, 1208) may extend out from the opening of the side of the bathtub (e.g., recesses 18, 20 of bathtub side opening 14) and one or more channel portions (e.g., channel portions 1210, 1212, 1214, 1216) may be defined within and along at least a portion of the periphery of the bathtub door (e.g., rim 22 of bathtub door 12). In some embodiments, protruding portions may be integral with or built-into recesses of the opening in the side of the bathtub. In some embodiments, at least one of the one or more compressible seals may be positioned within at least one of the one or more channel portions of the door such that the at least one compressible seal is configured to be compressed by at least one protruding portion of the one or more protruding portions within the at least one channel in response to magnetic attraction between the one or more magnetic elements and the one or more corresponding metallic elements to form a water-tight seal between the door and the side of the bathtub.

For example, one or more compressible seals (e.g., compressible seals 1218, 1220, 1222, 1224) may be positioned within at least one of the one or more channel portions (e.g., channel portions 1210, 1212, 1214, 1216) of the bathtub door (e.g., bathtub door 12). In this example, the at least one compressible seal (e.g., compressible seals 1218, 1220, 1222, 1224) may be configured to be compressed by at least one protruding portion (e.g., protruding portions 1202, 1204, 1206, 1208) within the at least one channel portion in response to magnetic attraction between the one or more magnetic elements (e.g., magnetic elements 1226, 1228) and the one or more corresponding metallic elements (e.g., corresponding metallic elements 1230, 1232) to form a water-tight seal between the bathtub door (e.g., bathtub door 12) and the side of the bathtub.

In some embodiments, the one or more protruding portions extending from the at least a portion of the periphery of the opening in the side of the bathtub may include a pair of protruding portions extending from the at least a portion of the periphery of the opening in the side of the bathtub and the one or more channel portions within and along at least a portion of the periphery of the door may include a pair of channel portions within and along at least a portion of the periphery of the door. Referring again to the example of FIG. 12 and in some embodiments, water-tight sealing system 100 may include a pair of protruding portions on each side of bathtub side opening (e.g., protruding portions 1202 and 1204 and protruding portions 1206 and 1208) and a pair of corresponding channel portions on each side of bathtub door 12 (e.g., corresponding channel portions 1210 and 1212 and corresponding channel portions 1214 and 1216). In some embodiments, at least one of the one or more corresponding metallic elements may be positioned between the pair of protruding portions extending from the at least a portion of the periphery of the opening in the side of the bathtub and at least one of the one or more magnetic elements may be positioned between the pair of channel portions within and along at least a portion of the periphery of the door. In this example, magnetic element 1226 may be positioned in a portion of rim 22 of bathtub door 12 between channel portions 1210, 1212 and compressible seals 1218, 1220 positioned with channel portions 1210, 1212 and magnetic element 1228 may be positioned in a portion of rim 22 of bathtub door 12 between channel portions 1214, 1216 and compressible seals 1222, 1224 positioned with channel portions 1214, 1216. Additionally, corresponding metallic element 1230 may be positioned in a portion of recess 18 of bathtub side opening 14 between protruding portions 1202, 1204 and corresponding metallic element 1232 may be positioned in a portion of recess 20 of bathtub side opening 14 between protruding portions 1206, 1208.

Accordingly, when bathtub door 12 is moved into a closed position, magnetic attraction between magnetic elements 1226, 1228 and corresponding metallic elements 1230, 1232 may cause protruding portions 1202, 1204, 1206, 1208 to engage channel portions 1210, 1212, 1214, 1216 and compress compressible seals 1218, 1220, 1222, 1224. In this manner, the 1) interlocking of protruding portions 1202, 1204, 1206, 1208 and channel portions 1210, 1212, 1214, 1216 and 2) compressing of compressible seals 1218, 1220, 1222, 1224 may form a water-tight seal between the bathtub door (e.g., bathtub door 12) and the side of the bathtub.

While an example of a single pair of protruding portions and corresponding channel portions has been described, it will be appreciated that any number of protruding portions and corresponding channel portions may be used within the scope of the present disclosure. Further, while an example has been described with a metallic element positioned between a pair of protruding portions and a magnetic element positioned between a pair of channel portions, it will be appreciated that any number of metallic elements and/or magnetic elements may be positioned around any number of protruding portions and/or channel portions within the scope of the present disclosure.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A water-tight sealing system for a bathtub door comprising:
an opening in a side of a bathtub;
a door coupled to the bathtub and configured to close the opening in the side of the bathtub;
one or more magnetic elements positioned on at least one of at least a portion of a periphery of a door and at least a portion of a periphery of the opening in the side of the bathtub;
one or more metallic elements positioned on at least the other of the at least a portion of the periphery of the door and at least a portion of the periphery of the opening in the side of the bathtub; and
one or more compressible seals coupled to and positioned along the periphery of the door and against the one or more magnetic elements such that the one or more compressible seals are configured to be compressed between the one or more magnetic elements and the one or more corresponding metallic elements when the door is closed;
wherein magnetic attraction between the one or more magnetic elements and the one or more corresponding metallic elements is configured to compress the one or more compressible seals to form a water-tight seal between the door and the side of the bathtub.

2. The water-tight sealing system of claim 1, wherein the one or more magnetic elements positioned on at least a portion of a periphery of the door include a plurality of magnetic elements substantially uniformly-spaced around the periphery of the door, thus defining a plurality of substantially uniformly-spaced magnetic elements.

3. The water-tight sealing system of claim 1, wherein the one or more magnetic elements positioned on at least a portion of a periphery of the door include a continuous magnetic element extending around the periphery of the door.

4. The water-tight sealing system of claim 1, wherein the one or more magnetic elements positioned on at least a portion of a periphery of the door include a first set of magnetic elements positioned along upper edges of the door and a continuous magnetic element positioned around a lower edge of the door.

5. The water-tight sealing system of claim 1, wherein the one or more magnetic elements are encased within one or more sleeves coupled to the one or more compressible seals.

6. The water-tight sealing system of claim 1, wherein the one or more magnetic elements are configured to maintain a water-tight seal between the door and the side of the bathtub while the bathtub is at least partially filled with water.

7. The water-tight sealing system of claim 1, further comprising:
one or more protruding portions extending from at least a portion of the periphery of the opening in the side of the bathtub; and
one or more channel portions within and along at least a portion of the periphery of the door;
wherein at least one of the one or more compressible seals are positioned within at least one of the one or more channel portions of the door such that the at least one compressible seal is configured to be compressed by at least one protruding portion of the one or more protruding portions within the at least one channel portion in response to a magnetic attraction between the one or more magnetic elements and the one or more corresponding metallic elements to form a water-tight seal between the door and the side of the bathtub.

8. A water-tight sealing system for a bathtub door comprising:
an opening in a side of a bathtub;
a door coupled to the bathtub and configured to close the opening in the side of the bathtub;
one or more magnetic elements positioned on at least one of at least a portion of a periphery of a door and at least a portion of a periphery of the opening in the side of the bathtub;
one or more corresponding magnetically-coupleable elements positioned on at least the other of the at least a portion of the periphery of the door and at least a portion of the periphery of the opening in the side of the bathtub;
one or more protruding portions extending from at least a portion of the periphery of the opening in the side of the bathtub;
one or more channel portions within and along at least a portion of the periphery of the door; and
one or more compressible seals positioned within the one or more channel portions of the door such that the one or more compressible seals are configured to be compressed by the one or more protruding portions within the one or more channel portions in response to a magnetic attraction between the one or more magnetic elements and the one or more corresponding magnetically-coupleable elements to form a water-tight seal between the door and the side of the bathtub.

9. The water-tight sealing system of claim 8, wherein the one or more corresponding magnetically-coupleable elements include at least one of:
one or more metallic elements, and
one or more cooperating magnetic elements.

10. The water-tight sealing system of claim 8, wherein the one or more magnetic elements positioned on at least a portion of a periphery of the door include a plurality of magnetic elements substantially uniformly-spaced around the periphery of the door, thus defining a plurality of substantially uniformly-spaced magnetic elements.

11. The water-tight sealing system of claim 8, wherein the one or more magnetic elements positioned on at least a portion of a periphery of the door include a continuous magnetic element extending around the periphery of the door.

12. The water-tight sealing system of claim 8, wherein the one or more magnetic elements positioned on at least a portion of a periphery of the door include a first set of magnetic elements positioned along upper edges of the door and continuous magnetic element positioned along a lower edge of the door.

13. The water-tight sealing system of claim 8, wherein the one or more magnetic elements are encased within one or more sleeves coupled to the one or more compressible seals.

14. The water-tight sealing system of claim 8, wherein the one or more protruding portions extending from the at least a portion of the periphery of the opening in the side of the bathtub include a pair of protruding portions extending from the at least a portion of the periphery of the opening in the side of the bathtub, and wherein at least one of the one or more corresponding magnetically-coupleable elements is positioned between the pair of protruding portions extending from the at least a portion of the periphery of the opening in the side of the bathtub.

15. The water-tight sealing system of claim 14, wherein the one or more channel portions within and along at least a portion of the periphery of the door include a pair of channel portions within and along at least a portion of the periphery of the door, and wherein at least one of the one or more magnetic elements is positioned between the pair of channel portions within and along at least a portion of the periphery of the door.

16. A water-tight sealing system for bathtub door comprising:
an opening in a side of a bathtub;
a door coupled to the bathtub and configured to close the opening in the side of the bathtub;
a pair of protruding portions extending from at least a portion of the periphery of the opening in the side of the bathtub;
a pair of channel portions within and along at least a portion of the periphery of the door;
one or more magnetic elements positioned on at least a portion of a periphery of the door, wherein at least one magnetic element is positioned between the pair of protruding portions extending from the at least a portion of the periphery of the opening in the side of the bathtub;
one or more corresponding metallic elements positioned on at least a portion of a periphery of the opening in the side of the bathtub, wherein at least one corresponding metallic element is positioned between the pair of channel portions within and along at least a portion of the periphery of the door; and
a compressible seal positioned within each channel portion of the pair of channel portions of the door such that each compressible seal is configured to be compressed by the pair of protruding portions within the pair of channel portions in response to a magnetic attraction between the one or more magnetic elements and the one or more corresponding metallic elements to form a water-tight seal between the door and the side of the bathtub.

17. The water-tight sealing system of claim 16, wherein the one or more magnetic elements positioned on at least a portion of a periphery of the door include a plurality of magnetic elements substantially uniformly-spaced around the periphery of the door, thus defining a plurality of substantially uniformly-spaced magnetic elements.

18. The water-tight sealing system of claim 16, wherein the one or more magnetic elements positioned on at least a portion of a periphery of the door include a continuous magnetic element extending around the periphery of the door.

19. The water-tight sealing system of claim 16, wherein the one or more magnetic elements positioned on at least a portion of a periphery of the door include a first set of magnetic elements positioned along upper edges of the door and continuous magnetic element positioned along a lower edge of the door.

20. The water-tight sealing system of claim 16, wherein the one or more magnetic elements are encased within one or more sleeves coupled to the one or more compressible seals.
